(19) United States
(12) Patent Application Publication
(10) Pub. No.: US 2024/0414171 A1
(43) Pub. Date: Dec. 12, 2024

(54) ADDRESS VALIDATION FOR CONNECTION ESTABLISHMENT

(71) Applicant: Intel Corporation, Santa Clara, CA (US)

(72) Inventors: Bo CUI, Shanghai (CN); Zhan XUE, Shanghai (CN); Tingkai CHEN, Shanghai (CN)

(21) Appl. No.: 18/808,610

(22) Filed: Aug. 19, 2024

(30) Foreign Application Priority Data
Jul. 31, 2024 (WO) PCT/CN2024/108696

(51) Int. Cl. H04L 9/40; H04L 67/141

(52) U.S. Cl. CPC H04L 63/12; H04L 63/1458; H04L 67/141

(57) ABSTRACT

Examples described herein relate to an interface and circuitry. The circuitry can perform offloaded performance of a cryptographic handshake with a client in connection with initiation of a quick User Datagram Protocol Internet Connections (QUIC) connection with the client. In some examples, the cryptographic handshake comprises process a first client hello datagram from the client, the first client hello datagram is consistent with QUIC, and the offloaded performance of the cryptographic handshake with the client is offloaded from a processor to the circuitry.

### PRIORITY CLAIM

This application claims the benefit of priority to Patent Cooperation Treaty (PCT) Application Number PCT/CN2024/108696, filed Jul. 31, 2024. The entire contents of that application are incorporated by reference.

### BACKGROUND

Data centers provide processing and storage resources that can be accessed by applications. For example, automobiles, smart phones, laptops, tablet computers, or internet of things (IoT) devices can leverage data centers to perform data analysis, data storage, or data retrieval. Processing and storage resources are connected together using high speed networking devices such as network interfaces, switches, or routers.

Networking devices utilize various protocols for communications among processing and storage resources. For example, Quick User Datagram Protocol (UDP) Internet Connections (QUIC) is a protocol that provides for end-to-end communication services between applications. An example specification for QUIC is Internet Engineering Task Force (IETF) 9000 (May 2021) and Network Working Group, “Manageability of the QUIC Transport Protocol,” draft-ietf-quic-manageability-10 (February 2021).

QUIC prescribes completing connection establishment and cryptographic handshakes in one round-trip time (1-RTT). More specifically, to establish a connection, endpoints perform authenticated key exchange along with an authenticated transport parameters exchange at the same time. Before establishing a connection, a server receives the handshake messages in the kernel driver, transfers the handshake messages from kernel to user space, parses the handshake messages by symmetric decryption, and processes the handshake messages by asymmetric encryption.

The 1-RTT transport and cryptographic handshakes can reduce connection setup latency. However, 1-RTT transport and cryptographic handshakes can also expose the resource-intensive QUIC server to potential vulnerabilities during the initial handshake, making it susceptible to first-flight attacks. First-flight attacks involve flooding the server with first messages to cause the server to over utilize hardware and/or software resources in performing cryptographic operations.

To mitigate this type of attack, Internet Engineering Task Force (IETF) Request for Comments (RFC) 9000 (2021) has introduced an additional round-trip with a retry token exchange to perform an address validation operation that validates the client's Internet Protocol (IP) address before initiating resource-intensive cryptographic operations such as key exchange and signature verification. More specifically, a QUIC server generates a token in response to the first client initial message and proceeds with subsequent cryptographic handshakes only if the client retries the message with a valid token.

### BRIEF DESCRIPTION OF THE DRAWINGS

FIG. 1 shows an example system.

FIG. 2 depicts an example process.

FIG. 3 depicts an example process.

FIG. 4 depicts an example network interface device.

FIG. 5 depicts an example system.

### DETAILED DESCRIPTION

While address validation prevents server exploitation in traffic amplification attacks toward the client and safeguards the server against malicious connections from clients, address validation can impose an additional burden on the processors in the server and can increase the latency of server-client connection setup. Various examples can offload address validation from a software stack performed by the server to a hardware device. When the address validation is enabled for a QUIC handshake, various examples can offload address validation from a processor to a device (e.g., a network interface device, a switch or router, or accelerator). The network interface device, switch, or router can be part of a network infrastructure for cloud servers, edge servers and terminals. To perform address validation, the device can perform at least: decoding of Client Initial Messages, generate responses, and perform token validation. Various examples can reduce central processing unit (CPU) utilization for address validation and free CPU resources to perform other operations, such as network applications. By offloading address validation to a device, various examples can reduce processor utilization faced during a distributed denial of service (DDOS) attack by first-flight attacks.

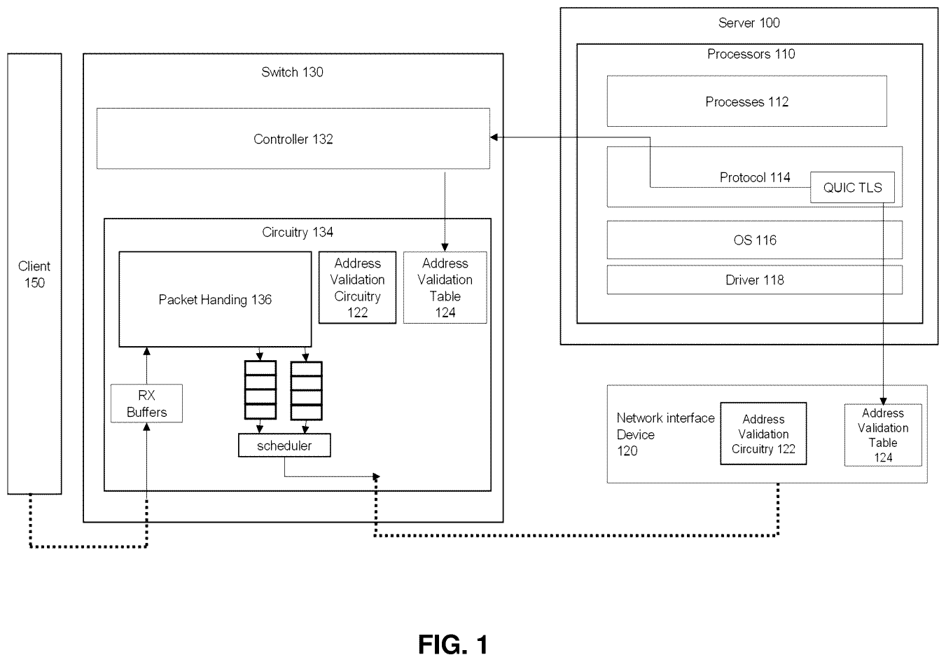

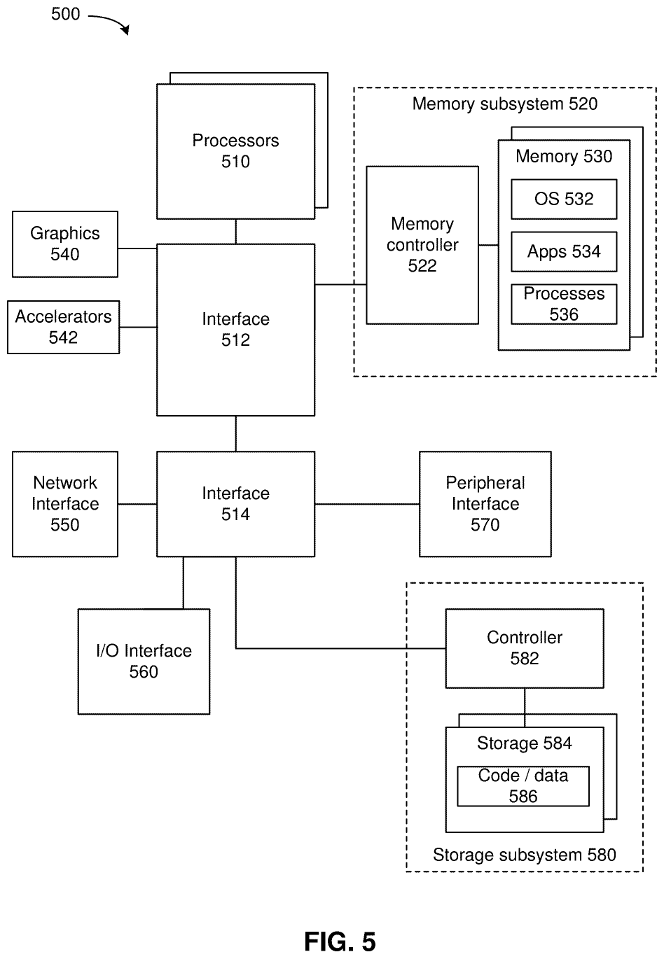

FIG. 1 depicts an example system. Server 100 can include one or more processors, memory, circuitry, and software described at least with respect to FIG. 5. Processors 110 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry.

Processor 110 can execute processes 112. Process 112 can include one or more of: application, process, thread, a virtual machine (VM), microVM, container, microservice, or other virtualized execution environment. In some examples, process 112 can perform Kubernetes pods, Docker containers, networking applications, web servers or browsers (e.g., Hypertext Transfer Protocol/3 (HTTP3)), or other processes. Process 112 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure.

Processor 110 can execute operating system (OS) 116 and device driver 118 for network interface device 120. For example, processes 112 can call an application programming interface (API) to communicate with operating system 116 and/or driver 118 to query or discover capability of address validation circuitry 122 to perform offload of QUIC connection setup, including offloaded address validation as part of a QUIC connection establishment. Operating system 116 and/or driver 118 can enable or disable address validation circuitry 122 to perform offloaded address validation as part of offloaded QUIC connection establishment. In some examples, address validation circuitry 122 can be integrated into network interface device 120 or connected to processors 110 via a device interface (e.g., Peripheral Component Interconnect express (PCIe), Compute Express Link (CXL), or others). In cloud virtualization scenarios, network interface device 120 can form multiple QUIC connections associated with multiple QUIC server contexts with distinct Internet Protocol (IP) and port configurations, enabling support for multiple tenants. Accordingly, OS 116 or device driver 118 can offload to network interface device 120, address validation circuitry 122 in switch 130, or circuitry connected to server 100 performance of: malicious activity detection, including verification of sender Internet Protocol (IP) addresses, DDOS detection, and Internet Protocol (IP) address spoofing detection.

To establish a new connection between client 150 and server 100, client 150 sends an initial packet to negotiate connection identifiers (IDs) with server 100. Client 150 can populate a Source Connection ID field with its chosen value in its initial packet and the Source Connection ID can be used by server 100 to set the Destination Connection ID when sending packets to client 150. Upon receiving the initial packet, server 100 can optionally verify a client's address by sending a retry packet that includes a token and, in response, client 150 is to copy the token and transmit the token in a new initial packet to continue the handshake process. The chosen connection IDs can be included in the QUIC transport parameters, which are authenticated during the Transport Layer Security (TLS) handshake process.

For example, a process executing on client 150 can initiate a QUIC connection with one or more of processes 112 executing on processor 110 by transmission of a client hello (CH) message to network interface device 120. At (1), device driver 118 can report a capability to perform offloaded QUIC address validation during a QUIC connection probe/initialization phase. At (2), during a QUIC connection startup phase, the server executed QUIC software stack 114 (e.g., in user space) queries for an address validation capability through a socket control message (e.g., Linux cmsg). If the capability is available, the connection context is provisioned into network interface device 120 after the QUIC service is operating. The context can include one or more of: Destination Internet Protocol (IP) address, UDP port, QUIC version number. Network interface device 120 can include a classifier that can use the context to identify the Client Initial message (the first message in a QUIC connection). The context can also include an integrity key used for retry Token generation and metadata for packet construction.

QUIC stack 114 executed by processors 110 can provision address validation table 124 during a QUIC connection initialization phase. Address validation table 124 can include QUIC server information, QUIC Address Validation Key, and Ethernet Information. QUIC server information can include the host QUIC server's IP address, UDP port (e.g., 8443), and version ID (e.g., v1). QUIC Address Validation Key can include private information used to generate secure Tokens across various connections. Ethernet information can include metadata to construct the QUIC response packet.

Address validation circuitry 122 can determine permitted or denied packet traffic based on access to address validation table 124. Address validation table 124 can classify packet flows in one or more of: pass list based on source IP addresses or other packet header information, fail list based on source IP addresses or other packet header information, or others. Based on receipt of a packet associated with a flow that is in a fail list, address validation circuitry 122 can notify server 100 of an attempt to connect and issue an error notification, log an error, and/or contact a data center administrator. Based on a packet being associated with a flow on a pass list, server 100 can proceed with one or more of: address validation or a QUIC connection handshake procedure, as defined in section 7 of IETF 9000 (May 2021).

At (3), a server-executed network device driver 118 (e.g., in kernel space) can check the status of incoming Client Initial packets. For example, if a Valid Address Validation (VAV) flag in a received packet is clear and the packet is associated with a pass list, the packet is not a Client Initial packet and can be processed by server 100 and QUIC connection establishment with client 150 can proceed by protocol stack 114, OS 116, and/or driver 118. For example, if the VAV flag is clear, an error log can be generated, indicating a potential attack has occurred. For the potential attack case, address validation failure could be detected by network interface device 120, and the VAV flag is cleared by network interface device 120 to flag the address validation error, to notify protocol stack 114, OS 116, and/or driver 118 about this potential attack. Server 100 executed QUIC stack 114 (e.g., in user space) can receive the packet from kernel space through a socket interface.

In some examples, address validation circuitry 122 can be implemented as part of a system-on-a-chip (SoC). Various examples of address validation circuitry 122 can be implemented as a discrete device, in a die, in a chip, on a die or chip mounted to a circuit board, in a package, or between multiple packages, in a server, in a CPU socket, or among multiple servers. Processors 110 and/or network interface device 120 can access address validation circuitry 122 by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processors 110, network interface device 120, and/or address validation circuitry 122) can be enclosed in one or more semiconductor packages. A semiconductor package can include metal, plastic, glass, and/or ceramic casing that encompass and provide communications within or among one or more semiconductor devices or integrated circuits.

For example, if a VAV flag in the packet is set, a VAV bit is encoded into packet metadata for user space access. For example, if the VAV flag is set in the packet and the packet is associated with a flow in a pass list, address validation can be offloaded for performance by address validation circuitry 122. At (4), to perform address validation, address validation circuitry 122 can perform one or more of: (a) process first client hello (CH) message, (b) respond to CH message with retry token, and (c) process token validation from subsequent CH message. Examples of operations of address validation circuitry 122 are described herein.

An example of operations of address validation circuitry 122 is as follows. At (i), network interface device 120 receives a first Client Hello message from client 150. At network interface device 120 or server 100, address validation circuitry 122 can decode the message to extract the source IP address and ingress port information and subsequently generate a retry Token based on hashing [key, source IP address, ingress port]. At (ii), at network interface device 120 or server 100, address validation circuitry 122 can assemble a QUIC Retry message that includes the newly generated Token and information sourced from Address Validation Table 124. Network interface device 120 sends the QUIC Retry message to client 150. Address Validation Table 124 can include metadata (e.g., media access control (MAC) address of network interface device 120 or virtual local area network (VLAN) identifier) for Ethernet packet generation.

At (iii), upon receiving the Retry message, client 150 can proceed to send another message, a second Client Initial message with the Token embedded. At (iv), at network interface device 120 or server 100, address validation circuitry 122 can parse the Token within the second Client Hello message. If the token is invalid (not issued by server 100), the Client Hello is marked with a valid address validation (VAV) flag and an INVALID_TOKEN message is returned to close the connection. If the token is valid, server 100 starts a regular QUIC handshake procedure with client 150. Moreover, network interface device 120 can inform server 100 that offloaded address validation has passed so that server 100 can identify server a valid QUIC connection.

Address validation circuitry 122 can be implemented as one or more of: can include one or more of: a CPU, a processor core, GPU, NPU, GPGPU, FPGA, ASIC, TPU, MMU, or other circuitry.

In some examples, address validation of a QUIC connection establishment can be performed in switch 130 instead or, or in addition to network interface device 120 or server 100. If address validation circuitry 122 is part of switch 130 connected to server 100, a secure configuration channel between server 100 and switch 130 can be established when the QUIC service starts. An example of operations as part of QUIC connection establishment can be as follows. At (a), server 100 can initiate the QUIC service and establish a secure channel with controller 132 of switch 130. At (b), server 100 can load QUIC context [Destination IP address, source UDP port, version, key, and others] into switch 130 through the channel, so that validation can be performed by address validation circuitry 122 at switch 130. At (c), the Retry/INVALID_TOKEN packets generated by address validation circuitry 122 are sent from network interface device 120 to switch 130 so that L2 information (e.g., media access control (MAC) address of network interface device 120, priority bit (pbit), virtual local area network (VLAN) tag) are updated before sent to client 150. Accordingly, upstream from network interface device 120, switch 130 can detect an unauthorized attempt to form a QUIC connection with server 100 and stop the connection from forming and reduce compute and memory resource utilization of network interface device 120 and/or server 100.

While examples are described with respect to QUIC, address validation can be used for network protocols including WireGuard, TLS (e.g., TLS 1.3), InfiniBand, RDMA over Converged Ethernet (RoCE), RoCe v2, or others.

A packet can refer to various formatted collections of bits that may be sent across a network, such as Ethernet frames, Internet Protocol (IP) packets, Transmission Control Protocol (TCP) segments, User Datagram Protocol (UDP) datagrams, Real-time Transport Protocol (RTP) segments, and so forth. A packet can be associated with a flow. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

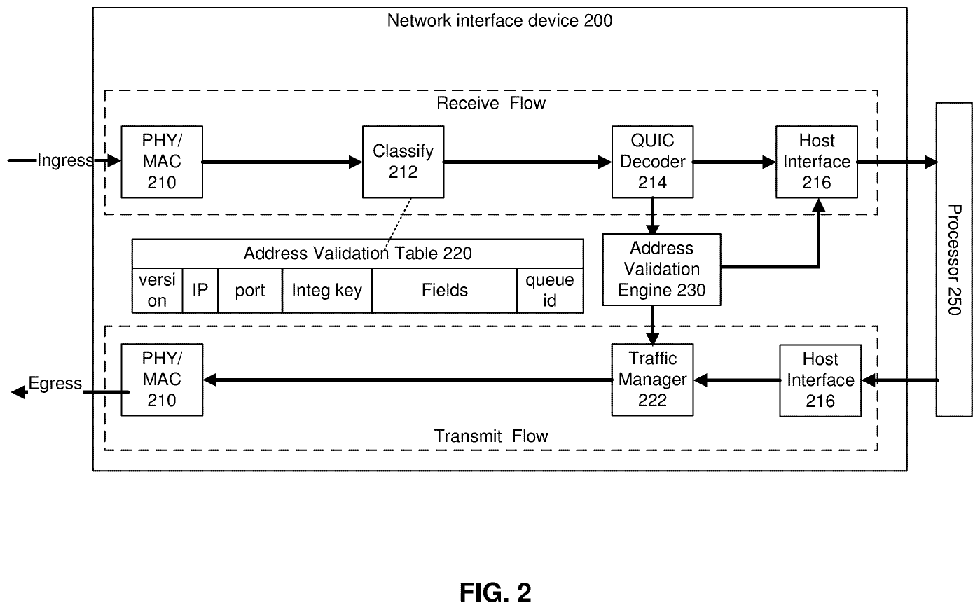

FIG. 2 depicts an overview of packet processing for Address Validation within a network interface device. After processing a received packet by a physical layer interface (PHY) and media access control (MAC) processor 210, classifier 212 can apply an access control list (ACL) for an ingress packet to classify the packet based on packet header fields [source IP address, ingress UDP ports, Packet Type] as an ingress client initial traffic. An ingress client initial traffic can include a QUIC Long Header packet with the initial connection flag set.

QUIC decoder 214 can retrieve a QUIC protocol version identifier of the received packet because the decoding of the QUIC Client Initial message varies depending on the QUIC protocol version. If the Token field (header.TokenLength==0) is invalid in the received packet, the received packet is the first client initial packet. QUIC decoder 214 can forward the received packet to Address Validation Engine (AVE) 230 for retry message generation. If the Token field is valid (header.TokenLength!=0), QUIC decoder 214 can determine that the second client initial message was received from a confirmed client, and the message in the received packet is forwarded to AVE 230 for token integrity verification.

AVE 230 can generate a retry message and validate an incoming token. For a Client Hello message without a token, AVE 230 can generate a unique token based on a hash of [source IP, source port, and a private key (stored within Address Validation Table 220)]. AVE 230 can generate a QUIC Retry message, and network interface device 200 can send the QUIC Retry message to the client through egress traffic manager 222. AVE 230 can construct the egress Ethernet packet based on fields [source IP address and source port] from the Client Hello and fields [source IP address, source port, packet fields (e.g., media access control (MAC) address of network interface device, priority bit (pbit), virtual local area network (VLAN) tag), transmit (Tx) queue identifier (Id)] from Address Validation Table 220.

For a Client Hello packet with a token, AVE 230 can validate the token's integrity using a hash of source IP address, source port, and integrity key. AVE 230 can forward valid Client Hellos to host interface 216 to copy to a memory for access by processor 250 and AVE 230 can drop invalid Client Hellos. When AVE 230 is implemented in a switch, the switch can forward a valid Client Hello message to the QUIC server through an upstream interface (e.g., Ethernet port). For the dropped Client Hellos, AVE 230 in network interface device 200 or a switch can generate another INVALID_TOKEN message and send the INVALID_TOKEN message to the client, indicating that the connection is closed and can log an error and contact a data center administrator.

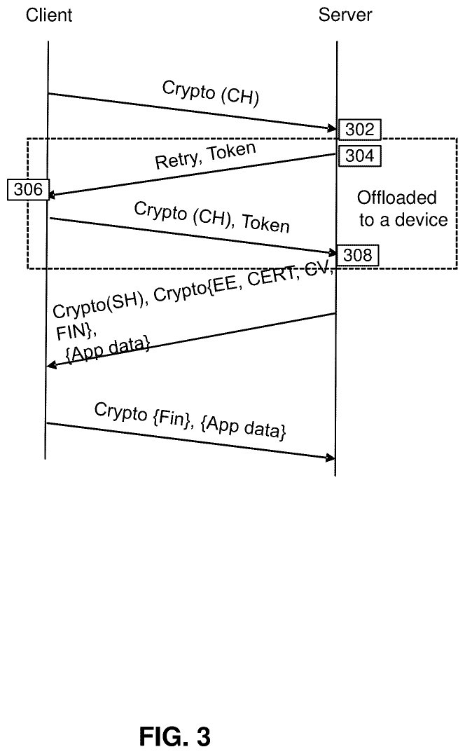

FIG. 3 provides an overview of an operation. At 302, server receives the first Client Hello message from a client. The server decodes the message to extract the IP and Port information, subsequently generating a retry Token by hashing [key, IP, Port]. At 304, the server assembles a QUIC Retry message that includes the newly generated token and information sourced from the Address Validation Table. The Address Validation Table can include metadata (e.g., source MAC address or VLAN identifier) for Ethernet packet generation. The server sends the message to the client.

At 306, upon receiving the retry message, the client sends another message, constituting the second Client Initial message, with the Token embedded. At 308, at a network interface device or an accelerator, an address validation engine parses the token within the second Client Hello message. If the token is invalid (not issued by this server), the Client Hello is marked with a valid address validation (VAV) flag and an INVALID_TOKEN message is returned to close the connection. If the token is valid, the server starts regular QUIC handshake procedure.

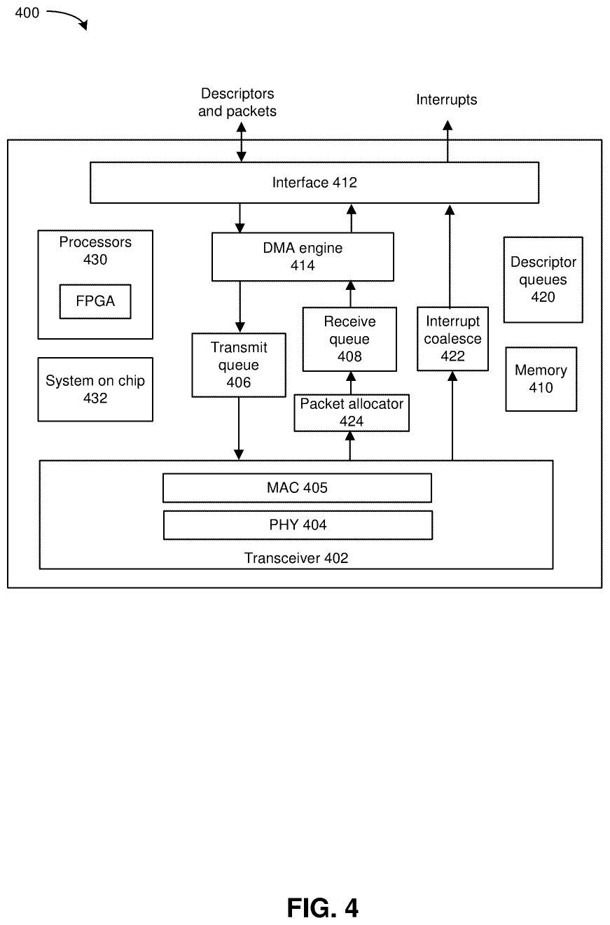

FIG. 4 depicts an example network interface device. In some examples, processors and/or FPGAs 430 can be configured to perform offloaded address validation and retry token verification in connection with a QUIC connection establishment, as described herein. Network interface device can be configured as an endpoint receiver that is multi home and receives time ordered packets, potentially reorders packets, and coalesces packet contents before copying packet contents up to a host. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 430, transmit queue 406, receive queue 408, memory 410, and interface 412, and DMA engine 414. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 404 and media access control (MAC) circuitry 405. PHY circuitry 404 can include encoding and decoding circuitry (not shown) to encode and decode data packets according to applicable physical layer specifications or standards. MAC circuitry 405 can be configured to perform MAC address filtering on received packets, process MAC headers of received packets by verifying data integrity, remove preambles and padding, and provide packet content for processing by higher layers. MAC circuitry 416 can be configured to assemble data to be transmitted into packets, that include destination and source addresses along with network control information and error detection hash values.

Processors 430 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 430.

Processors 430 can include a programmable processing pipeline or offload circuitries that is programmable by configurations compatible with P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into a coalesced packet. Network interface 400 provides this coalesced packet to an application.

Direct memory access (DMA) engine 414 can copy a packet header, packet payload, and/or descriptor directly from host memory to the network interface or vice versa, instead of copying the packet to an intermediate buffer at the host and then using another copy operation from the intermediate buffer to the destination buffer.

In some examples, processors 430 can be configured to perform packet re-ordering to re-order packets according to time stamp values and/or packet sequence numbers prior to copying packets through interface 412 to a host system.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Interface 412 can provide an interface with host device (not depicted). For example, interface 412 can be compatible with or based at least in part on PCI, PCIe, PCI-x, Serial ATA, and/or USB (although other interconnection standards may be used), or proprietary variations thereof.

FIG. 5 depicts a system. In some examples, circuitry of system 500 can perform offloaded address validation in connection and retry token verification with a QUIC connection establishment, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 532, a system administrator, and/or orchestrator can configure network interface 550 to perform offloaded address validation and retry token verification in connection with a QUIC connection establishment, as described herein.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU).

In some examples, management controller 544 can perform one or more of: retrieval of server identification and asset information (e.g., health state, temperature sensors and fans, power supply output levels, platform power consumption and thresholds, input/output (I/O) infrastructure data (e.g., host network interface controller media access control (MAC) address(es)) for devices to be managed (e.g., lights-out management (LOM) devices), hard drive status or fault reporting, network-based discovery of service endpoint, discovery of system topology (e.g., rack, chassis, server, node), reboot or power cycle server with connected devices, change boot order of devices, set power thresholds, alert or event notifications, event log access, access and configure management controller network settings, manage management controller user accounts, performing power distribution across the different parts of the system, allocating power management of the host system and network interface device 550, configuring frequency or power of operation of cores and network interface device 550, memory management of host system and network interface device 550, control of software updates of host system and network interface device 550, or control of firmware updates of host system and network interface device 550.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.
Example 1 includes one or more examples and includes an apparatus that includes an interface and circuitry to: perform offloaded performance of a cryptographic handshake with a client in connection with initiation of a quick User Datagram Protocol Internet Connections (QUIC) connection with the client, wherein: the cryptographic handshake comprises process a first client hello datagram from the client, the first client hello datagram is consistent with QUIC, and the offloaded performance of the cryptographic handshake with the client is offloaded from a processor to the circuitry.
Example 2 includes one or more examples, wherein the circuitry is to determine whether to proceed with the cryptographic handshake with the client based at least on a sender Internet Protocol (IP) address in the first client hello datagram.
Example 3 includes one or more examples, wherein the cryptographic handshake comprises: transmit a retry token to the client and perform validation of a token in a second client hello datagram received from the client.
Example 4 includes one or more examples, wherein the circuitry is to: based on the token validation failing, close a connection with the client and based on the token validation passing, permit QUIC connection establishment with the client.
Example 5 includes one or more examples, and includes one or more of: an accelerator or a network interface device, wherein the accelerator or the network interface device includes the circuitry.
Example 6 includes one or more examples, and includes a switch, wherein the switch includes the circuitry.
Example 7 includes one or more examples, and includes a server, wherein the server comprises the processor and wherein the server is coupled to the interface via a host interface and wherein the processor is to offload performance of the cryptographic handshake with the client to the circuitry and the processor is to perform connection establishment.
Example 8 includes one or more examples, and includes at least one non-transitory computer-readable medium comprising instructions stored thereon, that if executed by one or more processors, cause the one or more processors to: execute a driver to: configure a device to perform offloaded performance of establishment of a quick User Datagram Protocol Internet Connections (QUIC) connection with a client, wherein the offloaded performance of the establishment of a QUIC connection with the client comprises processing of at least one client hello datagram from the client, the at least one client hello datagram is consistent with QUIC, and the processing of the at least one client hello datagram from the client comprises token validation.
Example 9 includes one or more examples, wherein the establishment of the QUIC connection comprises: transmitting a retry token to the client in response to receipt of the at least one client hello datagram and verifying a second token received in the second client hello datagram as matching the retry token.
Example 10 includes one or more examples, and includes instructions stored thereon, that if executed by one or more processors, cause the one or more processors to: based on the token validation failing, close a connection with the client and based on the token validation passing, permit QUIC connection establishment with the client.
Example 11 includes one or more examples, wherein the device comprises one or more of: an accelerator, a switch, or a network interface device.
Example 12 includes one or more examples, wherein the offloaded performance of the establishment of the QUIC connection with the client mitigates distributed denial of service (DDOS) attacks.
Example 13 includes one or more examples, wherein: the driver is to offload performance of the establishment of the QUIC connection with the client to a switch that comprises the device and the switch permitting QUIC connection establishment based on validation of a second token received in the at least one client hello datagram.
Example 14 includes one or more examples, and includes a method comprising at an accelerator, performing offloaded performance of a cryptographic data exchange with a client in connection with forming a quick User Datagram Protocol Internet Connections (QUIC) connection with the client, wherein: the cryptographic data exchange comprises receiving a first client hello datagram from the client, sending a retry packet to the client, and receiving a second client hello datagram from the client and the offloaded performance of the cryptographic data exchange with the client is offloaded from a processor to the accelerator.
Example 15 includes one or more examples, and includes determining whether to proceed with forming the QUIC connection with the client based at least on a sender Internet Protocol (IP) address of the first client hello datagram.
Example 16 includes one or more examples, wherein the cryptographic data exchange comprises: transmitting a first token in the retry packet to the client and verifying a second token received in the second client hello datagram as matching the first token.
Example 17 includes one or more examples, and includes based on failing of the verifying of the second token, closing a connection with the client and based on passing of the verifying of the second token, permitting QUIC connection establishment with the client.
Example 18 includes one or more examples, wherein a switch comprises the accelerator and comprising: offloading to the switch performing the cryptographic data exchange with the client in connection with forming a QUIC connection with the client and the switch performing cryptographic data exchange with the client by: transmitting a first token in the retry packet to the client and verifying a second token received in the second client hello datagram as matching the first token.
Example 19 includes one or more examples, and includes based on failing of the verifying of the second token, closing a connection with the client and based on passing of the verifying of the second token, permitting QUIC connection establishment with the client.
Example 20 includes one or more examples, and includes loading QUIC context into the switch for the QUIC connection establishment, wherein the QUIC context comprises one or more of destination Internet Protocol (IP) address, source port identifier, QUIC version, or cryptographic key.

1. An apparatus comprising:
an interface and
circuitry to:
perform offloaded performance of a cryptographic handshake with a client in connection with initiation of a quick User Datagram Protocol Internet Connections (QUIC) connection with the client, wherein:
the cryptographic handshake comprises process a first client hello datagram from the client,
the first client hello datagram is consistent with QUIC, and
the offloaded performance of the cryptographic handshake with the client is offloaded from a processor to the circuitry.

2. The apparatus of claim 1, wherein the circuitry is to determine whether to proceed with the cryptographic handshake with the client based at least on a sender Internet Protocol (IP) address in the first client hello datagram.

3. The apparatus of claim 1, wherein the cryptographic handshake comprises:
transmit a retry token to the client and
perform validation of a token in a second client hello datagram received from the client.

4. The apparatus of claim 3, wherein the circuitry is to:
based on the token validation failing, close a connection with the client and
based on the token validation passing, permit QUIC connection establishment with the client.

5. The apparatus of claim 1, comprising one or more of: an accelerator or a network interface device, wherein the accelerator or the network interface device includes the circuitry.

6. The apparatus of claim 1, comprising a switch, wherein the switch includes the circuitry.

7. The apparatus of claim 1, comprising a server, wherein the server comprises the processor and wherein the server is coupled to the interface via a host interface and wherein the processor is to offload performance of the cryptographic handshake with the client to the circuitry and the processor is to perform connection establishment.

8. At least one non-transitory computer-readable medium comprising instructions stored thereon, that if executed by one or more processors, cause the one or more processors to:
execute a driver to:
configure a device to perform offloaded performance of establishment of a quick User Datagram Protocol Internet Connections (QUIC) connection with a client, wherein
the offloaded performance of the establishment of a QUIC connection with the client comprises processing of at least one client hello datagram from the client,
the at least one client hello datagram is consistent with QUIC, and
the processing of the at least one client hello datagram from the client comprises token validation.

9. The computer-readable medium of claim 8, wherein the establishment of the QUIC connection comprises:
transmitting a retry token to the client in response to receipt of the at least one client hello datagram and
verifying a second token received in the second client hello datagram as matching the retry token.

10. The computer-readable medium of claim 9, comprising instructions stored thereon, that if executed by one or more processors, cause the one or more processors to:
based on the token validation failing, close a connection with the client and
based on the token validation passing, permit QUIC connection establishment with the client.

11. The computer-readable medium of claim 8, wherein the device comprises one or more of: an accelerator, a switch, or a network interface device.

12. The computer-readable medium of claim 8, wherein the offloaded performance of the establishment of the QUIC connection with the client mitigates distributed denial of service (DDoS) attacks.

13. The computer-readable medium of claim 8, wherein:
the driver is to offload performance of the establishment of the QUIC connection with the client to a switch that comprises the device and
the switch permitting QUIC connection establishment based on validation of a second token received in the at least one client hello datagram.

14. A method comprising:
at an accelerator, performing offloaded performance of a cryptographic data exchange with a client in connection with forming a quick User Datagram Protocol Internet Connections (QUIC) connection with the client, wherein:
the cryptographic data exchange comprises receiving a first client hello datagram from the client, sending a retry packet to the client, and receiving a second client hello datagram from the client and
the offloaded performance of the cryptographic data exchange with the client is offloaded from a processor to the accelerator.

15. The method of claim 14, comprising:
determining whether to proceed with forming the QUIC connection with the client based at least on a sender Internet Protocol (IP) address of the first client hello datagram.

16. The method of claim 14, wherein the cryptographic data exchange comprises:
transmitting a first token in the retry packet to the client and
verifying a second token received in the second client hello datagram as matching the first token.

17. The method of claim 16, comprising:
based on failing of the verifying of the second token, closing a connection with the client and
based on passing of the verifying of the second token, permitting QUIC connection establishment with the client.

18. The method of claim 14, wherein a switch comprises the accelerator and comprising:
offloading to the switch performing the cryptographic data exchange with the client in connection with forming a QUIC connection with the client and
the switch performing cryptographic data exchange with the client by:
transmitting a first token in the retry packet to the client and
verifying a second token received in the second client hello datagram as matching the first token.

19. The method of claim 18, comprising:
based on failing of the verifying of the second token, closing a connection with the client and
based on passing of the verifying of the second token, permitting QUIC connection establishment with the client.

20. The method of claim 19, comprising:
loading QUIC context into the switch for the QUIC connection establishment, wherein the QUIC context comprises one or more of destination Internet Protocol (IP) address, source port identifier, QUIC version, or cryptographic key.
